(19) United States
(12) Patent Application Publication
(10) Pub. No.: US 2025/0307984 A1
(43) Pub. Date: Oct. 2, 2025

(54) SYSTEMS AND METHODS OF IMAGE REMOTING USING A SHARED IMAGE CACHE

(71) Applicant: ACTIVEVIDEO NETWORKS, LLC., Claremont, NC (US)

(72) Inventors: Maarten HOEBEN, San Jose, CA (US); Ronald A. BROCKMANN, San Jose, CA (US)

(73) Assignee: ACTIVEVIDEO NETWORKS, LLC., San Jose, CA (US)

(21) Appl. No.: 18/865,283

(22) PCT Filed: May 10, 2023
(86) PCT No.: PCT/US23/21730

§ 371 Date: Nov. 12, 2024

Related U.S. Application Data
(60) Provisional application No. 63/341,156, filed on May 12, 2022.

(51) Int. Cl. G06T 3/40; G06T 1/60

(52) U.S. Cl. CPC G06T 3/40; G06T 1/60

(57) ABSTRACT

A server system executing a third-party application accesses an image asset and provides a modified version of the image asset to the third-party application to be processed by the third-party application. The server system receives, from the third-party application, an indication that the modified version of the image asset has been down-scaled by the third-party application during processing. In response to receiving the indication that the modified version of the image asset has been down-scaled by the third-party application, the server system determines that the image asset is to be down-scaled at the server system. The server system down-scales the image asset and transmits the down-scaled version of the image asset to be stored in a shared image cache. The server system transmits the down-scaled version of the image asset to the first client device for display.

### CROSS REFERENCE TO RELATED APPLICATIONS

The present application is a 371 National Stage Patent Application claiming priority to International Patent Application No. PCT/US23/21730 filed on May 10, 2023, which claims the benefit of U.S. Provisional Patent Application No. 63/341,156 filed May 12, 2022, the contents of which are each incorporated herein by reference in their entirety.

### FIELD OF ART

The present invention relates generally to controlling display of media by a client, and more particularly to controlling, by a server, media assets displayed by a client after the media assets have been modified at the server.

### BACKGROUND

Many new interactive TV and video-on-demand (VOD) services are currently becoming available from services delivered by way of the Internet. Typically, these new services interact with a common web browser on a laptop, tablet, or smartphone or require a third-party application to run a dedicated client device such as a third-party Internet set-top box or smart TV. There is a need to interact with these services while reducing reliance on specialized client devices. However, relative to a common web browser or third-party application on a laptop, tablet or smartphone, a generic legacy TV set-top has limited resources in terms of processing power, graphical capabilities and memory, and is therefore typically not able to support most of these new interactive TV and VOD services due to such limitations.

### SUMMARY

Some embodiments of the present disclosure provide a virtualized application service system in which interactive TV and VOD services are provided by applications running on a server. Virtualizing these interactive TV and VOD applications on the server allows thin-client devices, including legacy set-top boxes, to appear as though the interactive and VOD applications are running locally. The present disclosure provides solutions to numerous problems that arise in the context of virtualizing application services for interactive TV and VOD applications, which together improve user experience and improve the efficiency of the server-client system by reducing bandwidth and memory requirements.

In accordance with some embodiments, a method performed at a server system executing a third-party application is provided. The method includes, for a first session of a plurality of sessions of the third-party application, the first session corresponding to a first client device, accessing an image asset. The method includes, at the server system, providing a modified version of the image asset to the third-party application to be processed by the third-party application. The method further includes receiving, from the third-party application, an indication that the modified version of the image asset has been down-scaled by the third-party application during processing. The method includes, in response to receiving the indication that the modified version of the image asset has been down-scaled by the third-party application, determining that the image asset is to be down-scaled at the server system. The method further includes, in accordance with a determination that the image asset is to be down-scaled at the server system, down-scaling, the image asset, transmitting the down-scaled version of the image asset to be stored in a shared image cache, wherein the plurality of sessions of the third-party application have access to the shared image cache, and transmitting the down-scaled version of the image asset to the first client device for display.

In some embodiments, a computer readable storage medium storing one or more programs for execution by one or more processors of an electronic device is provided. The one or more programs include instructions for performing any of the methods described above.

In some embodiments, an electronic device (e.g., a server system) is provided. The server system comprises one or more processors and memory storing one or more programs for execution by the one or more processors, the one or more programs including instructions for performing any of the methods described above.

It will be recognized that, in various embodiments, operations described with regard to the client may apply to a server and vice versa.

### BRIEF DESCRIPTION OF THE DRAWINGS

FIG. 1 is a top-level diagram illustrating a content delivery system, in accordance with some embodiments.

FIG. 2 is a diagram that illustrates the transformation of a video segment into a digest segment and its reconstruction into a reconstructed segment, in accordance with some embodiments.

FIG. 3 is a block diagram of a server system, in accordance with some embodiments.

FIG. 4 is a block diagram of a client device, in accordance with some embodiments.

FIGS. 5A-5C are block diagrams of fingerprints applied to image assets, in accordance with some embodiments.

FIGS. 6A-6B are block diagrams of a system for modifying image assets in a client-server environment, in accordance with some embodiments.

FIG. 7 is a flowchart for a method of scaling an image asset at a server system, in accordance with some embodiments.

### DETAILED DESCRIPTION

In accordance with some embodiments, computer systems provide an environment for third-party applications in which applications can run unmodified in a server environment in the third-party's domain (e.g., in a manner that is transparent to third-party applications that run on a client device).

Various embodiments described herein are directed to improvements of application server systems. In some embodiments, the applications are meant to be ported, installed and run locally on the client device. Instead, in some embodiments, methods are provided for running the application as, or similar to, unmodified Virtual Client Virtual Machines (VCVM) (e.g., and/or as containers) running on servers in a different domain than the client's or central facility's domain. By virtualizing the used APIs, such as OpenGL and OpenMAX, application functionality can be separated from the rendering functionality.

In some embodiments, the application modifies one or more image assets (e.g., image thumbnails, or other images to be displayed via a user interface of the application) from a version of the image asset stored at a backend (e.g., a CDN) by rotating, scaling, cropping, or modifying the colors of the image asset before displaying the image asset. However, in some embodiments, while the application is running on the server, the application may not have access to the original image data to modify, and the server feeds a dummy image asset to the application. The server must interpret how the application has modified the dummy image asset so that the server can perform the intended (e.g., as determined by the application) modification on the image asset (e.g., with the original image data), and/or can instruct the client to perform the modification on the image asset.

Various embodiments of a remote virtualization system and process that enables users of a plurality of various client devices to interact with video and graphic-rich interactive applications running in a remote server environment are provided. The resulting user experience is essentially equivalent to running these applications on the local client device, even when these devices require access to remote server resources such as various graphics rendering and other resources.

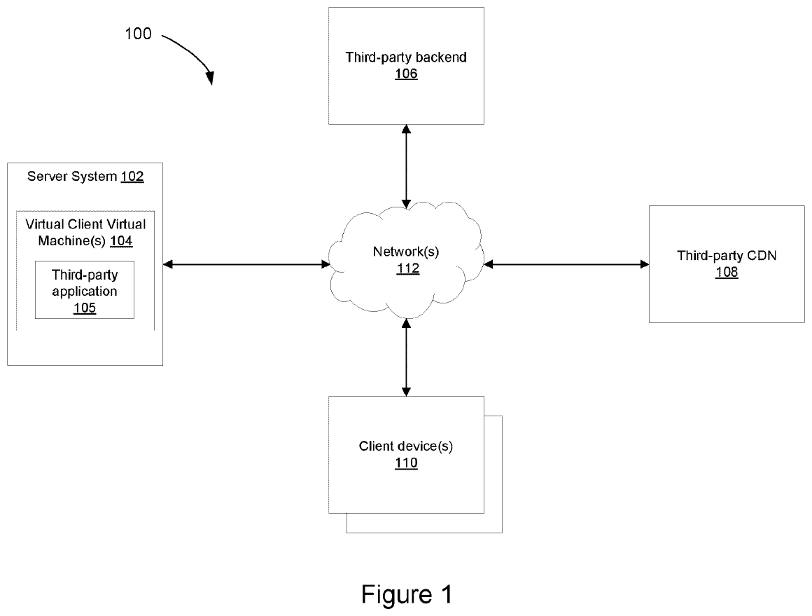

FIG. 1 is a top-level diagram illustrating a content delivery system, in accordance with some embodiments. System 100 includes server system 102 that is hosting one or more virtual client machines (VCVM(s)) 104. Each VCVM executes one or more third-party application(s) 105. System 100 further includes third-party backend 106, third-party content distribution network (CDN) 108, and client device 110. Server system 102, third-party backend 106, third-party CDN 108, and client device 110 communicate with each other via one or more network(s) 112.

In some embodiments, a respective VCVM 104 (e.g., a Linux container) is associated with one or more client devices 110. In some embodiments, the third-party application 105 and the third-party CDN 108 are associated with the same media providing service. In some embodiments, the third-party application 105 is configured to control playback of content provided by the third party CDN 108 (e.g., the third-party application 105 is a virtualized application that would normally be execute on the client device 110). For example, the client device 110 displays content provided by third-party CDN 108 while the third-party application 105 is executing on VCVM 104. In this way, client device 110 offloads execution of the third-party application to the server system 102, reducing the processing power and/or memory required by the client device 110. As such, instead of client device 110 controlling playback of media content that is retrieved from third-party CDN 108, server system 102 controls playback by issuing playback commands to client device 110.

In some embodiments, third-party backend 106 stores third-party backend data. In some embodiments, third-party backend 106 is in communication (e.g., via network(s) 112) with the third-party application 105 that is executing on virtual client virtual machine (VCVM) 104. In some embodiments, a plurality of third-party applications 105 (e.g., each third-party application associated with a content provider) execute on a same VCVM (e.g., a user is provided access to a plurality of third-applications that are executed on VCVM 104).

In some embodiments, third-party backend 106 receives requests (e.g., from third-party application 105 executing on VCVM 104) and issues responses in accordance with third-party backend data. For example, the user selects a title from the user interface to watch, and in response to the selection, the third-party application 105 queries either the backend 106 or the CDN 108 to find out how to get the actual media content. In response to the query, third-party backend 106 performs a lookup to determine where (e.g., a directory or server) the first media content item is stored, and third-party backend 106 issues a response to the third-party application 105 that identifies where to retrieve the first media content item from the identified location of storage (e.g., at third-party CDN 108). Using this information, the third-party application 105 uses the network API to download the media content. In some embodiments third-party backend 106 receives other types of queries (e.g., queries that do not require obtaining media assets, such as to initiate or end a user session). For example, third-party backend 106 issues responses to third-party application 105 upon receiving requests for user authentication, user profile information, recently viewed content, and/or identification of content (e.g., content catalogues) that are available to the user.

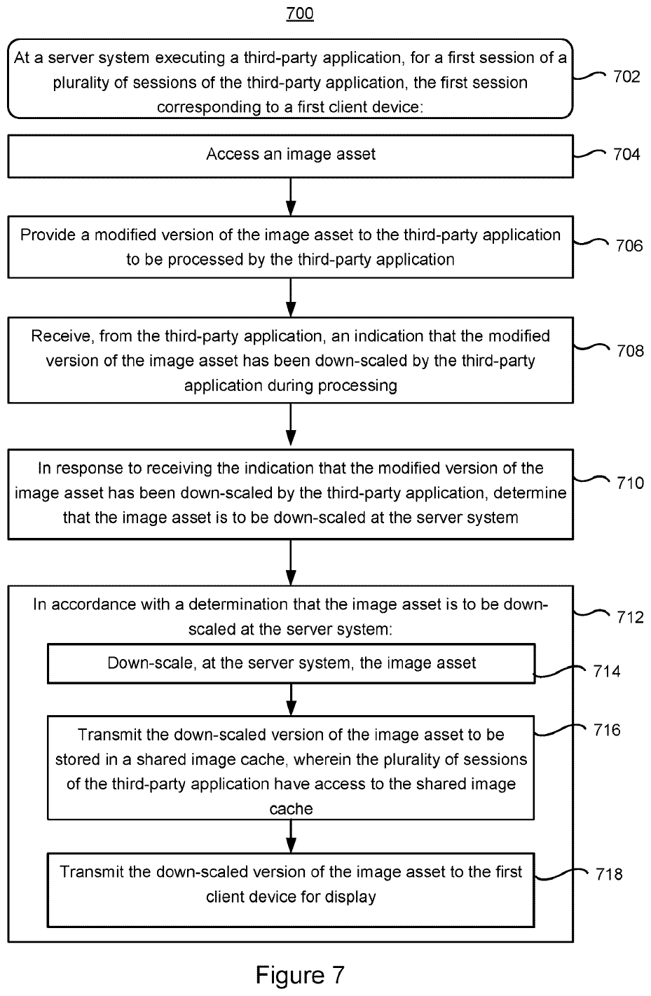

In some embodiments, third-party CDN 108 stores third-party content, including media content such as video assets and/or image assets. A media asset may contain a single representation for either audio or video, or combinations of various representations of audio and video. In some embodiments, a media asset includes a single representation of audio and a single representation of video in separate assets so the third-party application can select and request a respective asset that is applicable for the current conditions (e.g., bitrate) and/or based on user preference (e.g., audio in a certain language). Each media asset (e.g., audio and/or video asset) may be subdivided in multiple segments (e.g., referred to herein as media stream segments) that can be individually and progressively downloaded from the CDN 108. In some embodiments, as explained above, the third-party backend 106 issues a response to the third-party application 105 (e.g., or a third-party application proxy at the server system, as described below with reference to FIG. 7), and the third-party application 105 forwards instructions (e.g., the command) to client 110 (e.g., to retrieve the first media content item (e.g., media assets for the first media content item) from third-party CDN 108) and/or executes the command at the third-party application 105. In order for server system 102 to accurately control playback of media content at client device 110, server system 102 needs information about how much of the media asset the client device 110 has retrieved (e.g., which media stream segments the client device has retrieved) from CDN 108 (e.g., and/or current playback information regarding what the client device is currently playing back). In addition, one goal in virtualizing third-party application 105 is to avoid the need to modify third-party application 105 as compared to a version of the application that would run on client device 110. Often, applications that control presentation of video and other media content are configured to have access to the video or other media content. But, having been virtualized, it would be extremely inefficient to send the video or other media content to both the server system 102 and the client device 110 (where it is ultimately displayed).

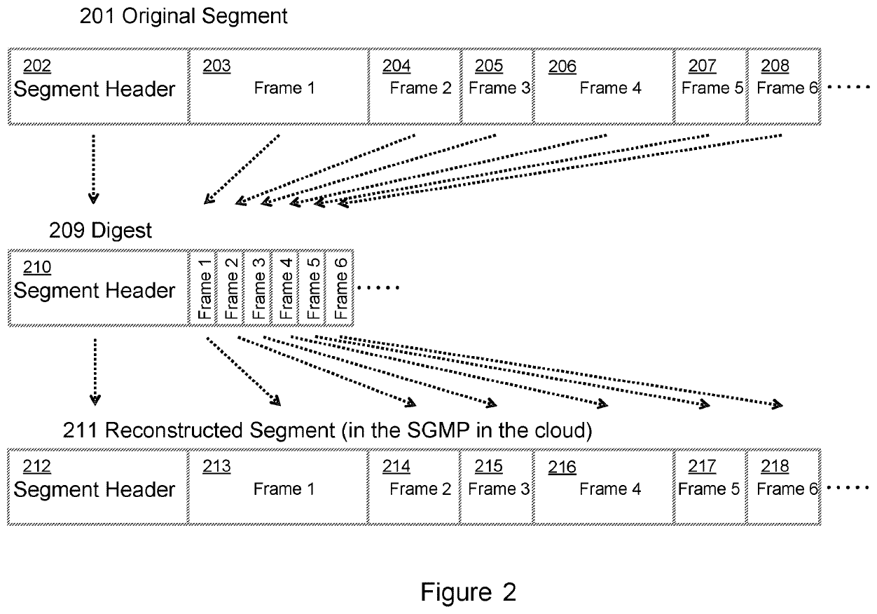

Accordingly, in some embodiments, upon receiving a media stream segment (e.g., corresponding to a portion of the media asset from third-party CDN 108), client device 110 generates a digest of the media stream segment (e.g., a file that includes information, such as metadata, from the media stream segment, but from which video/image content from the media stream segment has been removed or discarded, as described with reference to FIG. 2) and sends the digest to server system 102. The digest includes identifying information (e.g., header information, number of frames, etc.) about the media stream segment the client device 110 retrieved from CDN 108. Thus, server system 102 (e.g., and VCVM 104) receives the identifying information in the digest, processes the identifying information to generate a reconstructed media stream (e.g., by adding dummy video data), and provides the reconstructed media stream to third-party application 105 executing on VCVM 104. Third-party application recognizes the reconstructed media stream (e.g., is “tricked” into processing the reconstructed media stream as if it were the original media stream retrieved from CDN 108), and issues a playback command to initiate playback of the media stream segment (e.g., after the application confirms that the full media stream segment has been retrieved). The command to initiate playback is transmitted from third-party application 105 to client device 110.

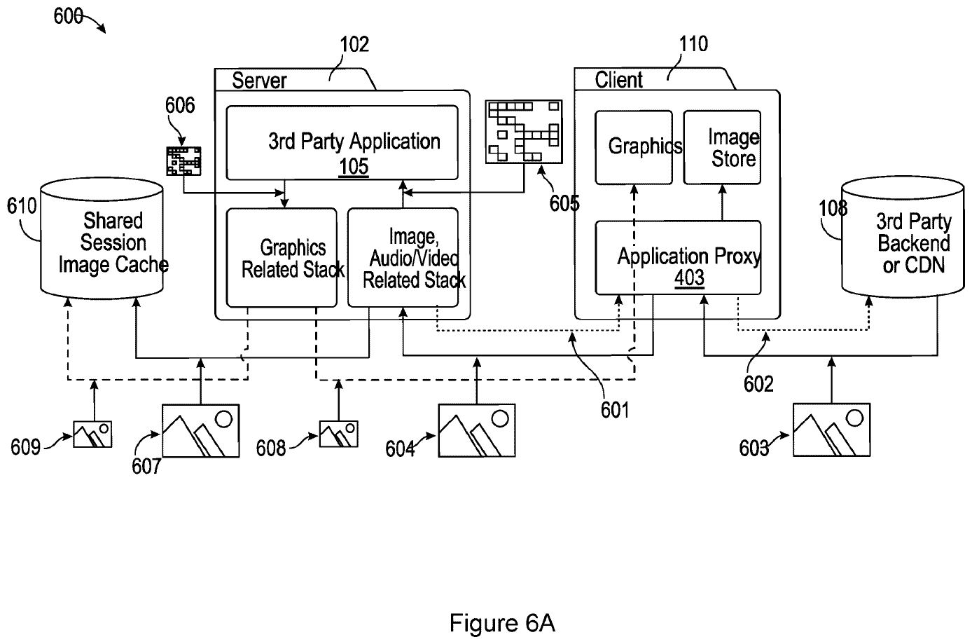

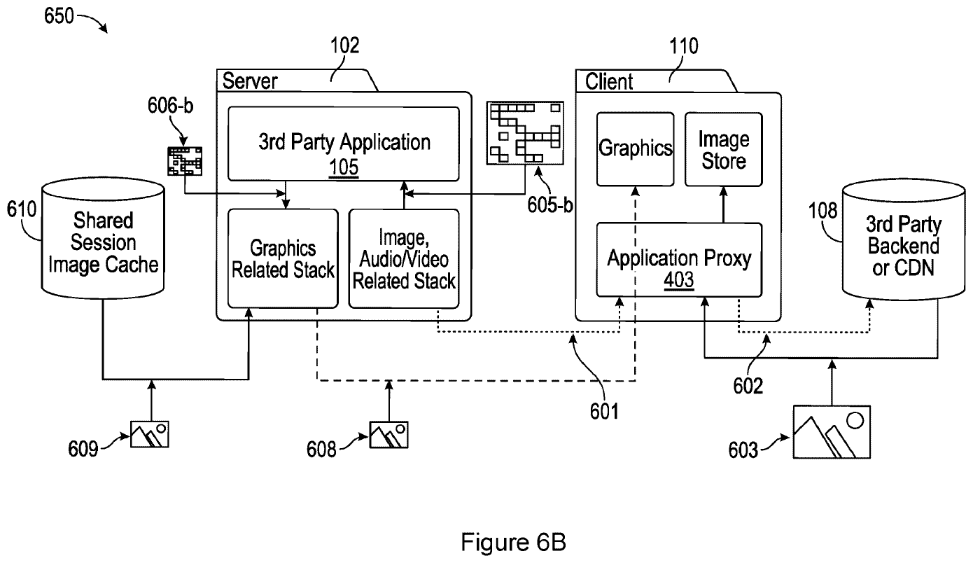

In some embodiments, for certain media assets, such as image assets, the image asset is forwarded from the client device 110 to server system 102 (e.g., without creating a digest). In some embodiments, as described with reference to FIG. 6B, the client device 110 need not forward media assets (e.g., image assets) to server 102 if the media assets are already stored in a shared session cache (e.g., shared session image cache 610). In some embodiments, the third-party application 105 transforms the media assets (e.g., changes a size, color encoding, etc.) before the media assets are to be displayed. However, in some embodiments, the media asset that is provided to the third-party application 105 is a dummy media asset (e.g., populated with dummy data instead of including original data of the media asset). As such, the server system must determine what, if any, transformations have been made to respective media assets (e.g., dummy media assets transformed by the third-party application 105) so that the server system can perform the transformations, or instruct the client device 110 to perform the transformations on the media assets that include the original data, before the client device 110 displays the media assets.

In response to receiving the command to initiate playback, client device 110 displays the unmodified media stream segment that was retrieved (e.g., downloaded) from CDN 108. Thus, client device 110 displays original content from CDN 108 based on a playback command controlled by the third-party application 105 executing on the server system 102. In some embodiments, third-party application 105 that is executing on the server system does not receive the original (e.g., unmodified) content from the CDN. Instead, third-party application 105 processes a segment reconstructed from the digest (e.g., a media stream segment without the video data) and issues the playback command based on the reconstructed digest. This reduces the amount of bandwidth sent between the server system and client device by allowing the client device 110 to directly download the media content from CDN 108, store the media content at the client, and send a digest (e.g., that has a smaller data size than the original media content) to the server system 102 such that the third-party application 105 executes without awareness that the VCVM 104 is separate from client device 110. Because client device 110 does not have to download or execute third-party application, client device 110 may be a “thin-client” that has limited processing power and/or memory.

FIG. 2 illustrates an example of generation of a digest 209 and a reconstructed segment 211. In some embodiments, a video stream comprises a plurality of media stream segments. The media stream segments are stored at CDN 108. In some embodiments, original segment 201 is obtained by client device 110. For example, client device 110 retrieves original segment 201 from the third-party CDN 108 (e.g., in response to the client receiving a command to retrieve the original segment 201).

Original Segment 201 depicts a hypothetical segment, such as an ISO base-media file-format (BMFF) segment as used in MPEG-dynamic-adaptive-streaming over HTTP (MPEG-DASH). Such a segment comprises a segment header 202 (e.g., which also corresponds to segment headers 210 and 212) and several frames (e.g., frames 203, 204, 205, 206, 207, and 208). It should be appreciated that the bulk of the segment data typically is the DRM-protected frame data. In some embodiments, the digest segment of the segment 209 is formed by removing the DRM-protected frame data and only including in the digest segment 209 the unmodified segment header (e.g., segment header 210 corresponds to unmodified segment header 202) and/or frame headers (such as picture headers and slice headers), including any codec specific headers, such as sequence headers, that are required to make an accurate reconstruction of the sequence of frames into reconstructed segment 211 (which includes frames 213, 214, 215, 216, 217, and 218).

In some embodiments, after client device 110 receives original segment 201 (e.g., from CDN 108), the client device 110 stores the original segment (e.g., in a buffer of the client device 110). In some embodiments, the client device 110 generates digest segment 209 and sends the digest segment 209 to server system 102. The server system 102 reconstructs the digest segment 209 into reconstructed segment 211 and provides reconstructed segment 211 to third-party application 105. Upon receiving reconstructed segment 211, third-party application 105 processes the reconstructed segment 211 (e.g., as if third-party application 105 had received original segment 201) and generates a playback command (e.g., a playback command that references and/or identifies original segment 201). The server system 102 sends the playback command to client device 110. In response to receiving the playback command, client device 110 initiates playback of original segment 201. In some embodiments, this process is repeated for each media stream segment that the client retrieves from CDN 108.

In some embodiments, instead of the client device 110 generating digest segment 209, client device forwards original segment 201 to server system 102 (e.g., and/or third party CDN 108 sends original segment 201 directly to server system 102), and the server system generates digest segment 209 (e.g., and stores the digest segment 209 in a cache at the server system). Then, in some embodiments, in response to a second client device requesting playback for the same media asset, the server system 102 retrieves the digest segment for the requested media segment, reconstructs the digest segment, and provides the reconstructed segment to the third-party application 105 (e.g., that corresponds to a user session of the second client device).

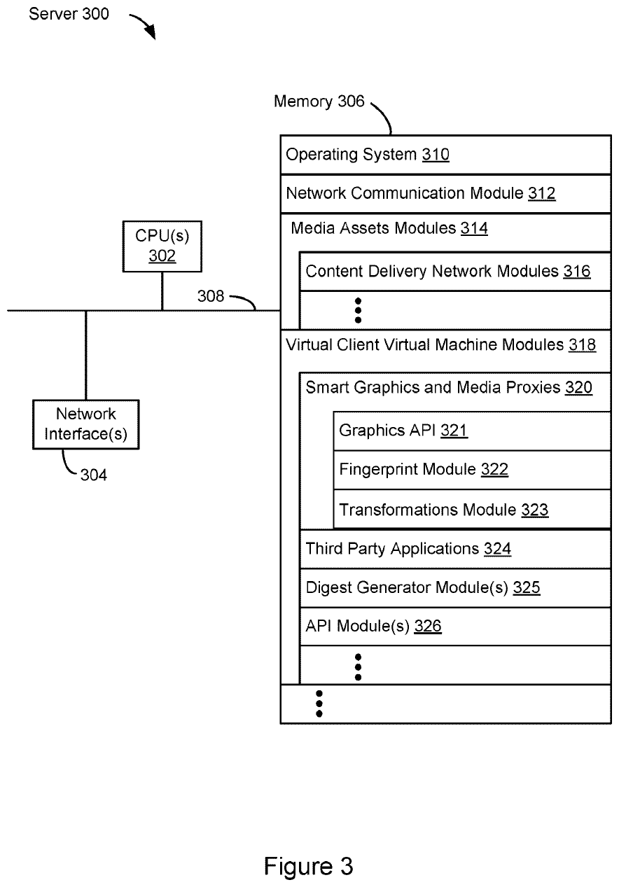

FIG. 3 is a block diagram illustrating an exemplary server computer system 300 in accordance with some implementations. In some embodiments, server computer system 300 is an application server system (e.g., server system 102) that executes virtual client virtual machine 104. The server computer system 300 typically includes one or more central processing units/cores (CPUs) 302, one or more network interfaces 304, memory 306, and one or more communication buses 308 for interconnecting these components. For example, server computing system 300 is communicatively coupled to shared session image cache 610 and client device 110.

Memory 306 includes high-speed random access memory, such as DRAM, SRAM, DDR RAM, or other random access solid-state memory devices; and may include non-volatile memory, such as one or more magnetic disk storage devices, optical disk storage devices, flash memory devices, or other non-volatile solid-state storage devices. Memory 306, optionally, includes one or more storage devices remotely located from one or more CPUs 302. Memory 306, or, alternatively, the non-volatile solid-state memory device(s) within memory 306, includes a non-transitory computer-readable storage medium. In some implementations, memory 306, or the non-transitory computer-readable storage medium of memory 306, stores the following programs, modules and data structures, or a subset or superset thereof:
an operating system 310 that includes procedures for handling various basic system services and for performing hardware dependent tasks;
a network communication module 312 that is used for connecting the server computer system 300 to other computing devices via one or more network interfaces 304 (wired or wireless) connected to one or more networks such as the Internet, other WANs, LANs, PANs, MANs, VPNs, peer-to-peer networks, content delivery networks, ad-hoc connections, and so on;
one or more media assets modules 314 for enabling the server computer system 300 to perform various functions, the media assets modules 314 including, but not limited to:
   content delivery network modules 316 for retrieving and/or processing media content received, for example, from CDN 108;
one or more virtual client virtual machine modules 318 for executing one or more VCVM(s) 104; in some implementations, the one or more virtual client virtual machine modules 318 include:
   smart graphics and media proxies 320 for tracking graphical states of client devices and/or processing graphics content, including one or more of:
      graphics API 321 for generating and/or sending GPU overlay instructions (e.g., openGL primitives) to a client device;
      fingerprint module 322 for generating and overlaying fingerprints on an image asset and/or for analyzing fingerprint data to determine transformations that have been performed on the fingerprint;
      transformations module 323 for performing one or more transformations of an image asset (e.g., scaling, coloring, cropping, etc.) and/or for sending instructions for performing the transformations to a client device;
   third party applications 324 for execution on the VCVM(s) 104 (e.g., applications 324 include third-party applications as described above);
   digest generator module(s) 325 for generating digest segments based on media stream segments; and
   API module(s) 326 for calling and/or using APIs, including for example, a Network API and an API of the third-party application (e.g., media playback API) to process playback of the media streams and/or digest segments.

In some implementations, the server computer system 300 includes web or Hypertext Transfer Protocol (HTTP) servers, File Transfer Protocol (FTP) servers, as well as web pages and applications implemented using Common Gateway Interface (CGI) script, PHP Hyper-text Preprocessor (PHP), Active Server Pages (ASP), Hyper Text Markup Language (HTML), Extensible Markup Language (XML), Java, JavaScript, Asynchronous Javascript and XML (AJAX), XHP, Javelin, Wireless Universal Resource File (WURFL), and the like.

Although FIG. 3 illustrates the server computer system 300 in accordance with some implementations, FIG. 3 is intended more as a functional description of the various features that may be present in one or more media content servers than as a structural schematic of the implementations described herein. In practice, items shown separately could be combined and some items could be separated. For example, some items shown separately in FIG. 3 could be implemented on single servers and single items could be implemented by one or more servers. The actual number of servers used to implement server computer system 300, and how features are allocated among them, will vary from one implementation to another and, optionally, depends in part on the amount of data traffic that the server system handles during peak usage periods as well as during average usage periods.

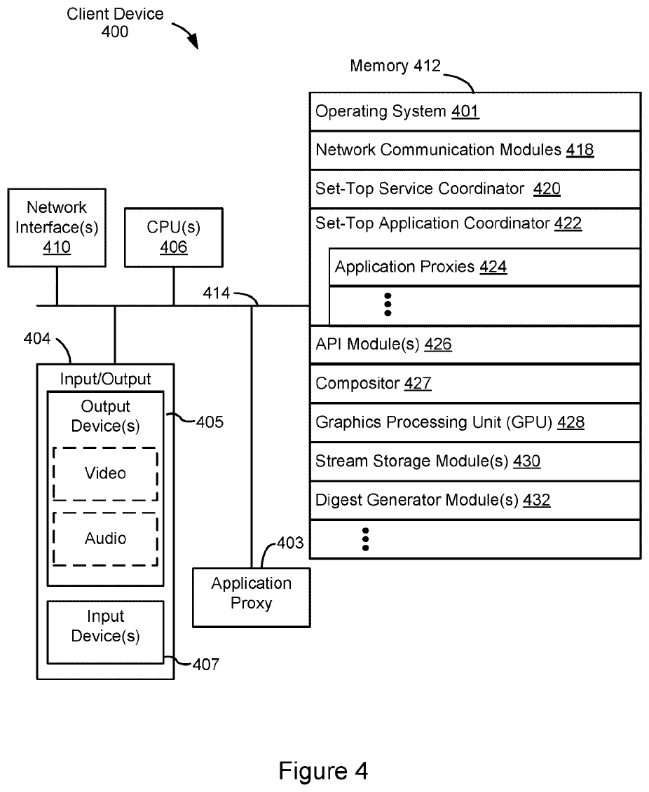

FIG. 4 is a block diagram illustrating an exemplary client device 400 (e.g., client device 110 of FIG. 1) in accordance with some implementations. The client device 400 typically includes one or more central processing units (CPU(s), e.g., processors or cores) 406, one or more network (or other communications) interfaces 410, memory 408, and one or more communication buses 414 for interconnecting these components. The communication buses 414 optionally include circuitry (sometimes called a chipset) that interconnects and controls communications between system components.

The client device includes input/output module 404, including output device(s) 405, such as video output and audio output, and input device(s) 407. In some implementations, the input devices 407 include a keyboard, a remote controller, or a track pad. For example, output device 405 is used for outputting video and/or audio content (e.g., to be reproduced by one or more displays and/or loudspeakers coupled with client device 400) and/or input device 407 is used for receiving user input (e.g., from a component of client device 400 (e.g., keyboard, mouse, and/or touchscreen) and/or a control coupled to client device 400 (e.g., a remote control)). Alternatively, or in addition, the client device includes (e.g., is coupled to) a display device (e.g., to display video output).

The client device includes application proxy 403 for communicating with third-party applications that are executing on the server system. For example, instead of storing and executing the application(s) on the client device, application proxy 403 receives commands (e.g., from a virtual machine in the server system) and, based on the received commands, instructs the client device to update the display accordingly.

In some implementations, the one or more network interfaces 410 include wireless and/or wired interfaces for receiving data from and/or transmitting data to other client devices 400, a server computer system 300, and/or other devices or systems. In some implementations, data communications are carried out using any of a variety of custom or standard wired protocols (e.g., USB, Firewire, Ethernet, etc.).

Memory 412 includes high-speed random-access memory, such as DRAM, SRAM, DDR RAM, or other random-access solid-state memory devices; and may include non-volatile memory, such as one or more magnetic disk storage devices, optical disk storage devices, flash memory devices, or other non-volatile solid-state storage devices. Memory 412 may optionally include one or more storage devices remotely located from the CPU(s) 406. Memory 412, or alternately, the non-volatile memory solid-state storage devices within memory 412, includes a non-transitory computer-readable storage medium. In some implementations, memory 412 or the non-transitory computer-readable storage medium of memory 412 stores the following programs, modules, and data structures, or a subset or superset thereof:
an operating system 401 that includes procedures for handling various basic system services and for performing hardware dependent tasks;
network communication module(s) 418 for connecting the client device 400 to other computing devices (e.g., client devices 110, server computer system 300, and/or other devices) via the one or more network interface(s) 410 (wired or wireless);
a set-top service coordinator 420 for communicating with an operator data center, such as an orchestrator for handling content services provided to the client device (e.g., set-top box);
a set-top application coordinator 422 for managing a plurality of third-party applications executing at the server system, the set-top application coordinator having additional module(s), including but not limited to:
   one or more application proxies 424 for communicating (e.g., graphical states) with third-party applications;
API Module(s) 426 for managing a variety of APIs, including, for example, OpenGL and/or OpenMAX;
Compositor 427 for drawing one or more overlays and/or instructions for compositing the video data with one or more graphics (e.g., overlays)
Graphics Processing Unit (GPU) 428 for rendering graphical content, including frame buffering and display control;
stream storage module(s) 430 (e.g., including one or more buffers) for storing original media content (e.g., from CDN 108), such as storing an original segment of a video stream; and
digest generator module(s) 432 for generating respective digest segments for respective media stream segments and sending the digest segments to the server system.

Features of the present invention can be implemented in, using, or with the assistance of a computer program product, such as a storage medium (media) or computer readable storage medium (media) having instructions stored thereon/in which can be used to program a processing system to perform any of the features presented herein. The storage medium (e.g., the memory 306 and the memory 412) can include, but is not limited to, high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. In some embodiments, the memory 306 and the memory 412 include one or more storage devices remotely located from the CPU(s) 302 and 406. The memory 306 and the memory 412, or alternatively the non-volatile memory device(s) within these memories, comprises a non-transitory computer readable storage medium.

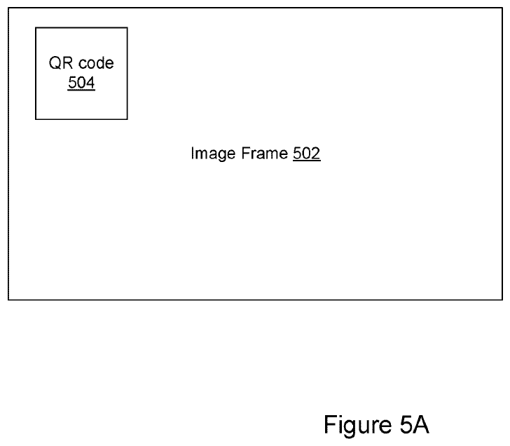

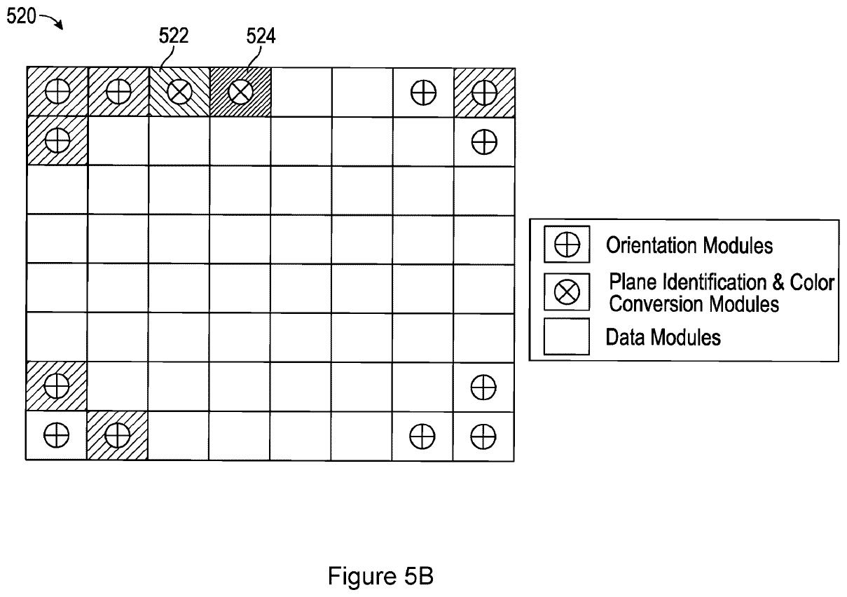

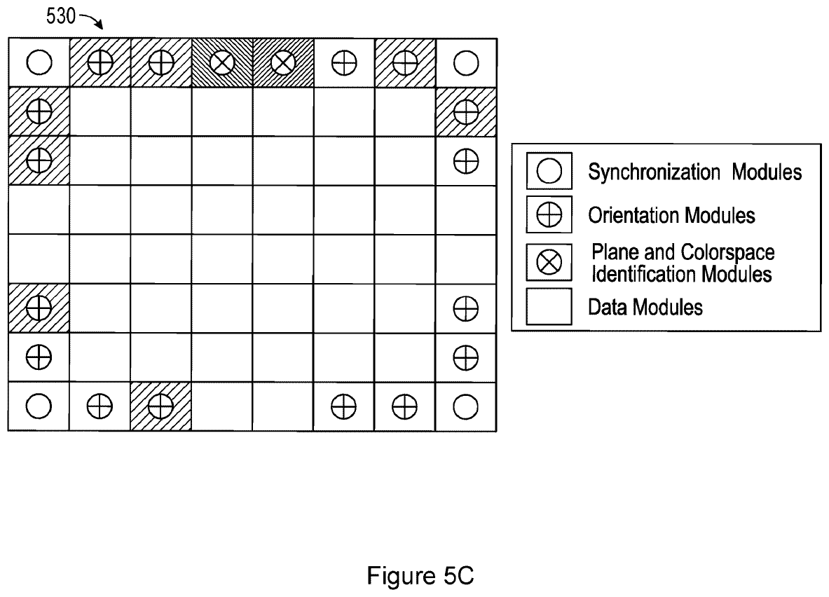

FIGS. 5A-5C illustrate examples of fingerprints added to a media asset (e.g., an image asset). For example, in the client-server environment described with reference to FIG. 1, a third-party application receives a request (e.g., from a user of client device 110) for content. In some embodiments, the request for content includes a request for one or more image assets. For example, in a video streaming third-party application, one or more image assets are requested to be displayed as thumbnail images or other images to be used in a user interface of the third-party application. In some embodiments, the third-party application, executing (e.g., unmodified) at the server system 102, transmits an instruction to obtain the image asset (e.g., from CDN 108), before the third-party application is enabled to modify (e.g., transform) the image asset for intended display. For example, the third-party application may need to perform one or more of: scaling, horizontal and/or vertical mirroring, rotation (e.g., by 90, 180 or 270 degrees), RGB(A) component reordering (e.g., swizzling), color-space conversions, pre-multiplication of red, green and blue components by an alpha component, conversion to interleaved or (individual) planar formats, and Gamma correction to an image asset (e.g., as stored at CDN 108) before displaying the image asset within the user interface of the third-party application.

Because the third-party application is executing at the server system, the server system requires a way to track how image assets (e.g., that are passed to the third-party application) have been modified by the third-party application, based on the image assets (e.g., and commands associated with the image assets) output by the third-party application at the server. For example, the server system (e.g., or client device) must perform the modifications (e.g., as intended by the third-party application) to a version of the original image asset (e.g., including the original image data of the image asset) because, in some embodiments, the third-party application (e.g., when executing on a client device) stores image assets (e.g., and modified versions of the image assets) in GPU memory (e.g., without an identifier of the image asset), such that the server system (e.g., without the methods described herein) would not be able to identify which image assets should be displayed and/or how the image assets are modified.

For example, the server system (e.g., Smart Graphics and Media Proxies 320) must perform (e.g., or instruct the client to perform) the same modifications to the image assets that the third-party application performs, so that the client device displays the image assets as intended by the third-party application. As such, a fingerprint is added to (e.g., overlaid with) an image asset, before passing the image asset to the third-party application, whereby the fingerprint's properties are modified in the same ways as an image asset during transformation of the image asset by the third-party application, while still maintaining certain properties of the fingerprint so that the server system can identify the image asset after it has been modified by the third-party application. In some embodiments, after identifying the image asset based on the fingerprint, the server system performs a same set of transformations (e.g., or instructs the client device to perform the same set of transformations) on the original image asset (e.g., having original image asset data without a fingerprint).

FIG. 5A illustrates using a QR code 504 as the fingerprint applied to an image asset (e.g., image frame 502). In some embodiments, a QR code is used because the QR code includes features that enables the server to determine a scale and orientation of the QR code. In some implementations, the QR code covers a relatively small portion of the image asset (e.g., less than 25%, less than 15%) and is optionally positioned in a corner of the image asset (e.g., the upper left corner). In some embodiments, the QR code is embedded over existing image data for an image asset. In some embodiments, the QR code is embedded over a blank image frame (e.g., or an image frame filled with dummy data that is distinct from the image data). For example, using a QR code of a small size and positioned at a predefined location allows the server system to sample and decode the QR code as-is (e.g., without a scanner to interpret the QR code). In some embodiments, a QR code is used such that data is embedded over the area of the QR code, which makes the QR code robust against loss of data (e.g., data that is lost while the third-party application modifies the image, and the QR code superimposed on the image).

FIG. 5B illustrates a fingerprint 520 that is not a QR code. For example, in some embodiments, embedding the fingerprint 520 illustrated in FIG. 5B in an image asset is more advantageous than embedding a QR code because the fingerprint of FIG. 5B includes a plurality of modules that are spread over the image asset's entire area, wherein each module of the plurality of modules is a same size (e.g., the module's side is rounded if the dimension is not an exact multiple of the number of modules). For example, in FIG. 5B, the fingerprint 520 comprises 8×8 modules (e.g., each module including data values that are to be interpreted by server system 102). In some embodiments, a subset of the modules of the fingerprint are filled with values that are input to identify transformations of the image. For example, based on the difference between the modules input to the third-party application, as compared to the modules output by the third party application, transformations that were made to the fingerprint within the third-party application (e.g., during processing) can be tracked by the server system 102. For example, because the modules are in fixed locations, inserting unique values (e.g., coded patterns) in each corner, and using certain modules to track changes to planes and/or colors, enables the server system 102 to determine the types of transformations the third-party application applied to a given image asset by comparing the transformed image asset (e.g., output by the third-party application), and how the fingerprint 520 was transformed along with the image asset, to the image asset that included the fingerprint 520 (e.g., that was input to the third-party application before transformation).

In some embodiments, within the plurality of modules, the corner modules (e.g., three modules for each corner) are used to determine an orientation of the image asset. For example, a distinct pattern is created in each corner (e.g., using three modules in each corner), wherein the respective values placed in each corner module are selected such that the corner module can be identified by looking at any two horizonal modules. Using the patterns of the corner modules, the server is enabled to determine whether the image (e.g., and module) has been rotated. For example, the server system is enabled to determine an angle of rotation based on the identification of values (e.g. coded patterns) in two of the horizontal modules (e.g., the two top corner modules). In some embodiments, using the corner modules, the server is enabled to detect a horizontal and/or vertical flip, in addition to an amount of rotation (e.g., 0 degrees, 90 degrees, 180 degrees, 270 degrees, etc.).

In some embodiments (e.g., after the server determines an orientation of the transformed image asset), the server samples and decodes modules that include other types of data. For example, using the decoded modules, the server identifies the original (e.g., pre-transformation) image asset dimensions (e.g., by performing a lookup after identifying the image asset), and the server determines whether the image asset has been scaled (e.g., by dividing the sampled image asset's (e.g., the transformed image asset) dimensions by the original image asset's dimensions). In some embodiments, the fingerprint is maintained (e.g., and detectable) even as an image asset is scaled down (e.g., to a thumbnail).

In some embodiments, the server system further determines whether the image asset has been transformed in color format and/or space, for example, using a subset of modules that were embedded with respective color values. For example, for each color as defined by the Red, Green, Blue, Alpha (RGBA) color values, bits are encoded for each color value, RGBA, for one or more modules in the image asset before transformation (e.g., the image asset input to the third-party application) as such: for the left module 522, Red: 0, Green: 1, Blue: 0, Alpha: 0.8 and for the right module 524, Red: 0, Green: 0, Blue: 1, Alpha: 0. In some embodiments, the server samples the transformed image asset and compares the sample from the encoding of the fingerprint (e.g., before the image asset was transformed). For example, the server is enabled to determine whether colors were swizzled (e.g., from RGBA to ABGR or ARGB), whether color components were pre-multiplied (e.g., by the alpha component), whether the color space was changed, and (e.g., for individual planar formats) the color plane.

In some embodiments, the image asset onto which the fingerprint is embedded is a substitute image asset (e.g., not the image asset that is to be displayed at the client device). For example, as described above, the image asset comprises “dummy” image data that is distinct from the image data, as well as the fingerprint, before being passed to the third-party application for transformation. As such, in some embodiments, additional security measures are taken in order to avoid an application generating an image that could be misinterpreted as the fingerprint (e.g., if the application generates an image with a QR code, or a chess board that appears similar to the modules described in FIG. 5B). For example, the server is enabled to add an error detection code, such as a hamming code, to the data modules of the fingerprint.

FIG. 5C illustrates an example of fingerprint 530 (e.g., an alternative to fingerprint 520 illustrated in FIG. 5B) that is not a QR code.

In some embodiments, fingerprint 530 includes at least 8x8 modules, each module having a same size, that are spread over at least a portion of (e.g., or the entirety of) the substitute image's area. In some embodiments, the color components in each module (e.g., other than plane/colorspace identification modules) and the module's alpha component are normalized to either 0 or 1. In some embodiments, the four corner modules are always set to 1, which are used to synchronize to the fingerprint (e.g., in case the fingerprint is applied partially, for example, to support cropping). In some embodiments, each of the corner modules are uniquely identified (e.g., and used to determine the orientation) by looking at two horizontal modules (e.g., regardless of the image's orientation), such that the 4 modules on the top row are used to identified the applied orientation, even after transformations could have altered the orientation.

In some embodiments, cropping of the image asset is supported when using fingerprint 530 by filling the area around the fingerprint 530 with a median value (e.g., a normalized 0.5 value), such that the device can scan for the top/left, bottom/left, and top/right corner modules (e.g., by sampling the second channel or first channel). In some embodiments, a minimum amount of configuration is added to the third party application (e.g., and/or to the application proxy and/or the graphics related stack), to enable specification of the type and parameters of the cropping that the application is likely to employ. For example, some applications require significant down-scaling, but don't crop an image asset while other applications may crop, but only do some form of center cropping, and/or do not do scrub-bar cropping (e.g., a portion of the image that overlaps with a scrub-bar area). If the system knows what it can expect, it places a fingerprint in such a way (e.g., within the frame) that the fingerprint remains legible after any transformation the application may perform on the image asset.

It will be understood that the fingerprints illustrated in FIGS. 5B and 5C are two examples of fingerprints that could be used in the methods described herein. In some embodiments, other fingerprints are used in addition to, or instead of, the fingerprints described above. In some embodiments, another fingerprint is used that has the following properties: modules of the fingerprint are in fixed locations relative to the scale of the image, mirroring and rotation properties can be quickly determined from the fingerprint, once orientation is known, the encoded data can be quickly de-serialized from the fingerprint, specific modules in the fingerprint are assigned to encode color planes and for detection of color transformations, and it can be determined that the code in the fingerprint is valid or damaged.

FIG. 6A is a block diagram of a system 600 for obtaining a remoted image that has been scaled but is not available in a shared session image cache. In some embodiments, while a third-party application 105 is running at server system 102, a request is received at the client device 110 (e.g., a request for content, a request for a catalog, etc.) from a user of the client device 110. In some embodiments, in response to receiving the request, the client device 110 forwards to the request to the server system 102, and the request is fed to the third-party application 105. In some embodiments, the third-party application 105, in response to receiving the request, determines one or more media assets (e.g., to be displayed at the client device 110 in response to the request), and sends an instruction 601 (e.g., to an application proxy executing on client device 110) to retrieve the one or more media assets from third-party CDN 108. For example, the one or more media assets include video and/or image assets. As described in the following example, the client device 110 (e.g., in response to the instruction 601) transmits a request 602 to the CDN 108 for an image asset 603. In some embodiments, the client device 110 stores the image asset 603 (e.g., in a local cache or image store) such that the client device 110 can retrieve the image asset from local memory (e.g., in response to an instruction from the third-party application 105).

In some embodiments, the application proxy 403 forwards the image asset 604 to the server system 102 (e.g., to an image stack at the server system). In some embodiments, image asset 604 is the same image asset as image asset 603 (e.g., is not modified). In some embodiments, image asset 604 is a modified version of image asset 603 (e.g., with dummy data in image asset 604 that is distinct from image data of image asset 603).

In some embodiments, the server system 102 forwards the image asset 607 (e.g., the image asset 604 is forwarded as image asset 607 (image asset 607 is the same image asset as image asset 604)) to be stored in a shared session image cache 610. For example, the shared session image cache 610 is stored at one or more servers (e.g., that may be separate from or include server system 102) and includes image assets (e.g., and optionally, video or other media assets) to be accessed by third party application 105. For example, multiple sessions hosting third-party application may be executing at server system 102 (e.g., at the same server, or at a plurality of servers of server system 102) concurrently (or at different times), each instance of the third-party application corresponding to a session of a respective client device (e.g., client 110). In some embodiments, each of the sessions of the third-party application has access to shared session image cache 610 such that the third-party application 105 and corresponding server system 102 for the session have access to assets already stored in the shared image cache 610. For example, after an image is stored in shared session image cache 610, in some embodiments, the server 102 forgoes requesting an image asset (e.g., image asset 604) from CDN 108 and/or client device 110, thus reducing bandwidth by forgoing the transmission of image data (e.g., as image asset 604) to the server system. For example, an initial (e.g., first) session of the third-party application requests image assets be sent to server system 102 (e.g., from CDN 108 and/or client device 110), and the image assets are stored (e.g., temporarily) in shared session image cache 610, such that subsequent sessions (e.g., a second session) of the third-party application may access the stored image assets without requesting them from the CDN 108 and/or client device associated with the subsequent session. Note that, in some embodiments, for a subsequent session, the server 102 continues to forward an instruction to client device 110 (e.g., an instruction generated by an instance of the third-party application 105 for the subsequent session) to retrieve an image asset (e.g., image asset 603) from CDN 108 (e.g., so that the client device 110 has the image asset 603 available at the client device for display).

In some embodiments, the server system 102 obtains a copy of the image asset from shared session image cache 610. For example, in FIG. 6A, image asset 607 is sent from server system 102 to the cache 610 for storage. However, for a subsequent session (e.g., for another client device, or a later session of a same client device), the server system 102 is enabled to retrieve the image asset from shared image cache 610 (e.g., instead of obtaining image asset 604).

In some embodiments, an image stack of the server system 102 adds a fingerprint 605 (e.g., corresponding to fingerprint 520 or fingerprint 530) to the image asset 604. In some embodiments, the smart graphics and media proxies 320 (FIG. 3) includes the image, audio/video related stack and graphics related stack illustrated in FIG. 6A. In some embodiments, the server system 102 removes (e.g., using the image, audio/video related stack) image data from the image asset 604. For example, the server system 102 replaces the image data in the image asset 604 with dummy data (e.g., or a blank frame) and the fingerprint 605 overlaid with the dummy data. In some embodiments, the server system 102 does not modify the image data of image asset 604, and overlays fingerprint 605 with the original image data of image asset 604.

In some embodiments, the server system 102 (e.g., using the image, audio/video related stack) inputs the fingerprinted image asset (e.g., image asset 604 with fingerprint 605 overlaid) to the third-party application 105 for processing. For example, third-party application 105, upon receiving the image asset 604, performs one or more transformations on the image assets and/or determines a display instruction for where and how to display the image asset 604 during the session.

For example, third-party application 105, which typically runs locally on a client device 110, is enabled to transform (e.g., rotate, scale, change colors, etc.) image assets and output display instructions for the image assets. Typically, while the third-party application 105 is running at a client device 110, the client device 110 displays the image asset as instructed by the third-party application 105. However, because third-party application 105 is executing at a server system 102 (e.g., wherein third-party application 105 is executed as an unmodified version of the third-party application that typically runs at client device 110), the server system 102 must interpret the instructions output from third-party application 105 (e.g., using a graphics related stack at server system 102) before sending a command to client device 110 to display the image assets (e.g., as determined by the third-party application). In addition to interpreting the instructions for display of image assets that are output from the third-party application 105, the server system 102 must also determine what transformations, if any, the third-party application 105 made to the image asset during processing, including whether the image asset has been rotated, scaled, color modified, etc.

In some embodiments, server system 102 determines what transformations have been made by third-party application 105 to the image asset 604 by analyzing the fingerprint 606 (e.g., which continues to be overlaid on the image asset), as output by the third-party application 105. For example, as described with reference to FIGS. 5A-5C, the server system 102 is enabled to determine the types of transformations based on how the fingerprint 606, which is output by the third-party application 105, has changed relative to the fingerprint 605 (e.g., corresponding to fingerprint 520 or fingerprint 530) that was input to the third-party application. In some embodiments, the server system 102 further uses the fingerprint 605 to identify which image asset the third-party application is referencing (e.g., wherein each fingerprint includes an identifier of the respective image asset).

The server system 102 is then enabled to either (i) transform the copy of the image asset 604 (e.g., or image asset 607 retrieved from the cache 610) at the server, and send the transformed version of the image asset back to client device 110 with display instructions, or (ii) instruct the client device to perform the transformation of the image asset (e.g., without sending a copy of the image asset to client device 110, since client device 110 has already retrieved image asset 603 from CDN 108). In some embodiments, the server system 102 determines, based on the type of transformation, whether to instruct the client to perform the transformation(s), or whether the server system 102 is to perform the transformation(s) and forward the transformed image asset to client device 110 (e.g., based at least in part on the processing resources required to perform the transformations).

In some embodiments, the detected transformation of the image asset includes a down-scaling transformation. In some embodiments, in accordance with a determination that the amount of down-scaling of the image asset is greater than a threshold amount of down-scaling, the server performs the down-scaling. For example, for significantly down-scaled images, the processing effort is large, and the quality impact (if not performed optimally) is high, but relatively little bandwidth is required to transmit such a small image from the server to the client, and thus the server system 102 performs the down-scaling, rather than relying on the processing power of the client device 110. In some embodiments, in accordance with a determination that the amount of down-scaling of the image asset is less than the threshold amount of down-scaling, the server instructs the client device 110 to perform the down-scaling. In some embodiments, the threshold corresponds to down-scaling to half resolution (e.g., or some other percentage of resolution).

In FIG. 6A, the server system 102 performs the downscaling of the image asset (e.g., in accordance with an amount of down-scaling determined from the size of fingerprint 606 relative to fingerprint 605). In some embodiments, after the image asset is down-scaled, the server system 102 sends a down-scaled version of image asset 609 to be stored in the shared session image cache 610 (e.g., such that, for a subsequent session, the server system 102 need not re-perform the downscaling, and instead can retrieve the already down-scaled version of the image asset 609 from shared session image cache 610, thereby reducing the processing load of the server system 102).

In some embodiments, after down-scaling the image asset, the server system 102 sends the down-scaled version of the image asset 608 (e.g., the same image asset as down-scaled version of the image asset 609) to the client device for display.

It will be understood that in some embodiments (e.g., when the amount of down-scaling required is less than the threshold amount), the server system 102 forgoes downscaling the image asset, and instead sends an instruction to the client device 110 for the client device 110 to perform the downscaling locally.

FIG. 6B illustrates a block diagram of a system 650 for obtaining an image from a shared session image cache during a subsequent session, in accordance with some embodiments. For example, as noted above, in some embodiments, during a subsequent session of the third-party application (e.g., corresponding to a distinct client device as the session described with reference to FIG. 6A, or a session for the same client device initiated at a later time), the server system 102 sends an instruction 601 to an application proxy of client device 110 to retrieve an image asset 603 from CDN 108 (e.g., wherein the client device 110 requests the image asset with a request 602), but the image asset is not forwarded from the client device 110 to the server system 102. Instead, the server system determines that the requested image asset is already stored in shared session image cache 610 (e.g., from a previous session). In some embodiments, the server system obtains the original (e.g., not down-scaled) image asset to input to the third-party application 105. In some embodiments, the server system does not request the original image asset, and inputs a fingerprint 605-b (e.g., overlaid on a blank frame, or on dummy image data) to third-party application 105. Third-party application processes the fingerprint 605-b and outputs fingerprint 606-b, and after the server system determines that the same transformations have been performed (e.g., by analyzing the fingerprint 605-b), the server system 102 retrieves the down-scaled (e.g., and otherwise transformed (e.g., rotated, colored, etc.)) image asset 609 from the shared session image cache, an sends the down-scaled version of the image asset 608 to client device 110 with a display instruction.

FIG. 7 illustrates a method 700 for down-scaling an image asset for display at a client device. In some embodiments, the method 700 is performed by a server computer system (e.g., server system 102, server system 300) that hosts one or more virtual client devices (e.g., VCVM), each virtual client device corresponding to a remote physical client device that plays back video content and/or displays image content received from a content server, as shown in FIG. 1. In some embodiments, the server system executes a third-party application, as described with reference to FIGS. 6A-6B. For example, instructions for performing the method are stored in the memory 306 and executed by the processor(s) 302 of the server computer system 300. Some operations described with regard to the process 1100 are, optionally, combined and/or the order of some operations is, optionally, changed. The server computer system (e.g., a server computing device) has one or more processors and memory storing one or more programs for execution by the one or more processors. In some embodiments, each physical client device is a thin client programmed to remote into a server-based computing environment.

In some embodiments, for a first session of a plurality of sessions of the third-party application (702), the first session corresponding to a first client device, the server system accesses (704) an image asset (e.g., from a shared image cache 610 or from CDN 108, or client device 110).

The server system provides (706) a modified version of the image asset to the third-party application to be processed by the third-party application. For example, the modified version of the image asset comprises the image asset with fingerprint 605 (FIG. 6A) overlaid. As described above, in some embodiments, the image data from the image asset is removed and fingerprint 605 is added. In some embodiments, the image data from the image asset remains, and fingerprint 605 is overlaid on the unmodified image data of the image asset.

The server system receives (708), from the third-party application, an indication that the modified version of the image asset has been down-scaled by the third-party application during processing. For example, as described with reference to FIG. 6A, the server system 102 determines, based on fingerprint 606 output from third-party application 105, transformations that were made to the image asset 604 (e.g., and fingerprint 605) by the third-party application 105 during processing of the image asset.

In response to receiving the indication that the modified version of the image asset has been down-scaled by the third-party application, the server system determines (710) that the image asset is to be down-scaled at the server system.

In accordance with a determination that the image asset is to be down-scaled at the server system (712), the server system down-scales (714) the image asset and transmits (716) the down-scaled version of the image asset to be stored in a shared image cache (e.g., as image asset 609), wherein the plurality of sessions of the third-party application have access to the shared image cache. The server system transmits (718) the down-scaled version of the image asset (e.g., as image asset 608) to the first client device for display.

In some embodiments, for a second session of the plurality of sessions of the third-party application corresponding to a second client device, after storing the down-scaled version of the image asset in the shared image cache for the first session, the server system receives a second request for the down-scaled version of the image asset. In response to the second request and in accordance with a determination that the server system is to perform the down-scaling, the server system retrieves the down-scaled version of the image from the shared image cache and sends the down-scaled version of the image asset to the second client device corresponding to the second session (e.g., as described with reference to FIG. 6B).

In some embodiments, the image asset is stored in the shared image cache for an initial session of the plurality of sessions (e.g., a non-down-scaled version of the image asset, such as the original image asset, is stored in shared session image cache 610). In some embodiments, the server system receives a request (e.g., from the third-party application) for a down-scaled version of an image asset, for display at the first client device (e.g., the server system obtains the down-scaled version of the image asset and sends it to the client device).

In some embodiments, the server system determines that the server system is to perform the downscaling and sends the downscaled send the downscaled image asset in accordance with the amount of downscaling satisfying a threshold amount of scaling. For example, as described above, for significantly down-scaled images, the effort is large, the quality impact (e.g., if performed sub-optimally) is high, but it takes relatively little bandwidth to transmit such a small image from the client to the server.

In some embodiments, the server system determines that the client is to perform the downscaling in accordance with the amount of downscaling failing to satisfy a threshold amount of scaling. For example, image assets that should be down-scaled to a less degree, e.g., half resolution (or another threshold amount), the down-scaling can happen with linear interpolation and the effort is moderate, quality impact acceptable, but bandwidth to transmit the image may be prohibitive.

In some embodiments, in accordance with a determination that the first client device is to perform the down-scaling, the server system sends an instruction to the first client device to down-scale the image asset without transmitting the image asset (e.g., downscaled or unmodified) to the first client device.

In some embodiments, the modified version of the image asset comprises a QR code (e.g., as the fingerprint) overlaid across the entire image (e.g., as described with reference to FIG. 5A).

In some embodiments, the modified version of the image asset comprises a plurality of modules placed in fixed locations (e.g., as the fingerprint), relative to the scale of the image, each module including data (e.g., as described with reference to FIG. 5B and FIG. 5C).

In some embodiments, a first subset, less than all, of the plurality of modules are assigned to data to encode orientation (e.g., as described with reference to FIG. 5B and FIG. 5C, a pattern is created on the corner modules (e.g., three modules for each corner) are used for orientation).

In some embodiments, a second subset, less than all, of the plurality of modules are assigned to encode color planes and for detection of color transformations. For example, as described with reference to FIG. 5B, modules 522 and 524 of the fingerprint are used to determine color transformations.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

2. A method comprising:
at a server system executing a third-party application:
for a first session of a plurality of sessions of the third-party application, the first session corresponding to a first client device:
accessing an image asset;
providing a modified version of the image asset to the third-party application to be processed by the third-party application;
receiving, from the third-party application, an indication that the modified version of the image asset has been down-scaled by the third-party application during processing;
in response to receiving the indication that the modified version of the image asset has been down-scaled by the third-party application, determining that the image asset is to be down-scaled at the server system; and
in accordance with a determination that the image asset is to be down-scaled at the server system:
down-scaling, at the server system, the image asset, thereby producing a down-scaled version of the image asset;
transmitting the down-scaled version of the image asset to be stored in a shared image cache, wherein the plurality of sessions of the third-party application have access to the shared image cache; and
transmitting the down-scaled version of the image asset to the first client device for display.

2. The method of claim 1, further comprising, at the server system, for a second session of the plurality of sessions of the third-party application corresponding to a second client device:
after storing the down-scaled version of the image asset in the shared image cache for the first session, receiving a second request for the down-scaled version of the image asset; and
in response to the second request and in accordance with a determination that the server system is to perform the down-scaling:
retrieving the down-scaled version of the image asset from the shared image cache; and
sending the down-scaled version of the image asset to the second client device corresponding to the second session.

3. The method of claim 1, wherein the image asset is stored in the shared image cache for an initial session of the plurality of sessions.

4. The method of claim 1, further including determining that the server system is to perform the downscaling and send the downscaled image asset in accordance with the amount of downscaling satisfying a threshold amount of scaling.

5. The method of claim 1, further including determining that the client is to perform the downscaling in accordance with the amount of downscaling failing to satisfy a threshold amount of scaling.

6. The method of claim 1, further comprising, in accordance with a determination that the first client device is to perform the down-scaling, sending an instruction to the first client device to down-scale the image asset without transmitting the image asset to the first client device.

7. The method of claim 1, wherein the modified version of the image asset comprises a QR code overlaid across the entire image asset.

8. The method of claim 1, wherein the modified version of the image asset comprises a plurality of modules placed in fixed locations, relative to the scale of the image asset, each module including data.

9. The method of claim 8, wherein a first subset, less than all, of the plurality of modules are assigned to data to encode orientation.

10. The method of claim 8, wherein a second subset, less than all, of the plurality of modules are assigned to encode color planes and for detection of color transformations.

11. A server system executing a third-party application, comprising:
one or more processors; and
memory storing instructions executable by the one or more processors for:
for a first session of a plurality of sessions of the third-party application, the first session corresponding to a first client device:
accessing an image asset;
providing a modified version of the image asset to the third-party application to be processed by the third-party application;
receiving, from the third-party application, an indication that the modified version of the image asset has been down-scaled by the third-party application during processing;
in response to receiving the indication that the modified version of the image asset has been down-scaled by the third-party application, determining that the image asset is to be down-scaled at the server system; and
in accordance with a determination that the image asset is to be down-scaled at the server system:
down-scaling, at the server system, the image asset, thereby producing a down-scaled version of the image asset;
transmitting the down-scaled version of the image asset to be stored in a shared image cache, wherein the plurality of sessions of the third-party application have access to the shared image cache; and
transmitting the down-scaled version of the image asset to the first client device for display.

12. (canceled)

13. A non-transitory computer-readable storage medium storing instructions, which, when executed by a server system that is executing a third-party application and that includes one or more processors, causes the one or more processors to perform a set of operations, comprising:
for a first session of a plurality of sessions of the third-party application, the first session corresponding to a first client device:
accessing an image asset;
providing a modified version of the image asset to the third-party application to be processed by the third-party application;
receiving, from the third-party application, an indication that the modified version of the image asset has been down-scaled by the third-party application during processing;
in response to receiving the indication that the modified version of the image asset has been down-scaled by the third-party application, determining that the image asset is to be down-scaled at the server system; and
in accordance with a determination that the image asset is to be down-scaled at the server system:
down-scaling, at the server system, the image asset, thereby producing a down-scaled version of the image asset;
transmitting the down-scaled version of the image asset to be stored in a shared image cache, wherein the plurality of sessions of the third-party application have access to the shared image cache; and
transmitting the down-scaled version of the image asset to the first client device for display.

14. (canceled)
